(19) United States
(12) Patent Application Publication
(10) Pub. No.: US 2024/0158924 A1
(43) Pub. Date: May 16, 2024

(54) ELECTROCHEMICAL CELL INCLUDING SOLUTION INFUSED LAYER

(71) Applicant: Verdagy, Inc., Moss Landing, CA (US)

(72) Inventor: John C. Goeltz, Marina, CA (US)

(21) Appl. No.: 18/508,759

(22) Filed: Nov. 14, 2023

Related U.S. Application Data
(60) Provisional application No. 63/383,608, filed on Nov. 14, 2022.

(51) Int. Cl. C25B 1/04; C25B 9/23

(52) U.S. Cl. CPC C25B 1/04; C25B 9/23

(57) ABSTRACT

An electrochemical cell comprises a first electrode configured for a first electrochemical half reaction, a first electrolyte solution in contact with the first electrode, a second electrode configured for a second electrochemical half reaction, a second electrolyte solution in contact with the second electrode, a separator positioned between the first electrode and the second electrode, and a first porous layer in contact with the first electrode, wherein the first porous layer is infused with a first specified solution comprising a first reactant for the first electrochemical half reaction.

### CROSS-REFERENCE TO RELATED APPLICATION

This application claims priority under 35 U.S.C. § 119(e) to U.S. Provisional Application Ser. No. 63/383,608, filed on Nov. 14, 2022, entitled “ELECTROCHEMICAL CELL INCLUDING POROUS LAYER,” the disclosure of which is incorporated herein by reference in its entirety.

### BACKGROUND

The production of hydrogen plays a key role because hydrogen gas (H₂) is required for many chemical processes. As of 2022, roughly 75 million tons of H₂ gas is produced annually worldwide for various uses, such as oil refining, in the production of ammonia (through the Haber process), in the production of methanol (though reduction of carbon monoxide), or as a fuel in transportation.

Historically, a large majority of H₂ (˜95% on a weight basis) was produced from fossil fuels (e.g., by steam reforming of natural gas, partial oxidation of methane, or coal gasification). Other methods of hydrogen production include biomass gasification, low- or no-carbon dioxide (CO₂) emission methane pyrolysis, and water electrolysis. Water electrolysis uses electricity to split water molecules into H₂ gas and oxygen gas (O₂). To date, electrolysis systems and methods have been more expensive than fossil-fuel based production methods. However, fossil-fuel based methods of H₂ production have generally resulted in increased CO₂ emission compared to electrolysis. Therefore, there is a need for cost-competitive and environmentally friendly water electrolysis systems and methods for H₂ gas production.

Water electrolysis to produce H₂ gas is typically performed under either acidic conditions (e.g., at a pH of 2 or less) or alkaline conditions (e.g., at a pH of 12 or more). There are many known benefits to operating in one of these conditions, including high solution conductivity and high activity for typical catalyst surfaces, such as platinum group metal or nickel based catalysts. In addition, most water electrolysis cells are operated at the same or substantially the same pH on both the anode and the cathode sides of the cell. Even when a pH differential is intentionally applied, e.g., by configuring an electrolyzer cell so that the anode and the cathode are operated at different local pHs, the pH differential will tend to equilibrate over time. It has been found, however, that maintaining a pH differential across an electrolyzer cell can be beneficial for modifying the cell voltage. For example, performing water oxidation to O₂ at the anode in a locally alkaline environment and water reduction to H₂ at the cathode in a locally acidic environment or an environment that is less alkaline than at the anode can reduce the effective nominal open circuit voltage by about 59 mV per pH unit difference at 25° C. Such operation can also improve safety and expand materials compatibility options. But, maintaining a pH differential can be inefficient and time-consuming, for example by requiring additional energy to be added to the system to maintain the pH differential.

### SUMMARY

The present disclosure describes systems and methods for water electrolysis to produce hydrogen gas (H₂), and in particular to an electrolyzer comprising one or more electrolyzer cells for the production of H₂ gas. For example, an electrolyzer cell according to the present disclosure includes one or more porous layers that are infused with a specified solution corresponding to one or both of the electrodes of the electrolyzer cell. The inclusion of the one or more infused porous layers can, for example, provide for easier maintenance of a pH differential between the anode and the cathode of the electrolyzer cell.

The present disclosure describes an electrochemical cell comprising a first electrode configured for a first electrochemical half reaction, a first electrolyte solution in contact with the first electrode, a second electrode configured for a second electrochemical half reaction, a second electrolyte solution in contact with the second electrode, a separator positioned between the first electrode and the second electrode, and a first porous layer in contact with the first electrode, wherein the first porous layer is infused with a first specified solution comprising a first reactant for the first electrochemical half reaction.

The present disclosure also describes a method of electrolysis, the method comprising providing an electrochemical cell comprising a separator having a first side and an opposing second side, a first electrode configured for a first electrochemical reaction positioned on the first side of the separator, a second electrode configured for a second electrochemical reaction positioned on the second side of the separator, and a first porous layer in contact with the first electrode. The method further comprises infusing the first porous layer with a first electrolyte solution comprising a first reactant for the first electrochemical half reaction, contacting the second electrode with a second electrolyte solution, passing current between the first electrode and the second electrode, and producing hydrogen gas (H₂) at one of the first electrode and the second electrode, and producing oxygen gas (O₂) at the other of the first electrode and the second electrode.

### BRIEF DESCRIPTION OF THE FIGURES

The drawings illustrate generally, by way of example, but not by way of limitation, various embodiments discussed in the present document.

FIG. 1 is a schematic diagram of an example electrolyzer cell for the electrolysis of water to produce hydrogen gas.

FIG. 2 is a graph of voltage responses for one configuration of a water electrolysis system operating with no pH differential (e.g., with both the anolyte and the catholyte having a pH of 14) compared to the same system operating with the anolyte having a pH of 14 and with the catholyte having pH of 7.

FIG. 3 is an exploded perspective view of an example electrode assembly comprising one or more infused porous layers that can be used in an electrolyzer cell, in accordance with the present disclosure.

FIGS. 4A-4H are cross-sectional side views of various configurations of electrode assemblies comprising one or more infused porous layers that can be used in an electrolyzer cell, in accordance with the present disclosure.

FIG. 5 is a cross-sectional view of an example electrolyzer cell comprising an anode pan assembly, a cathode pan assembly, and the example configuration of the electrode assembly comprising infused porous layers of FIG. 4A, in accordance with the present disclosure.

FIG. 6 is a close-up cross-sectional view of the example configuration of the electrode assembly comprising infused porous layers of FIG. 4D in the example electrolyzer cell of FIG. 5, in accordance with the present disclosure.

FIG. 7 is a close-up cross-sectional view of the example configuration of the electrode assembly comprising infused porous layers of FIG. 4G in the example electrolyzer cell of FIG. 5, in accordance with the present disclosure.

FIG. 8 is a graph of the voltage response to various current densities of the electrolyzer cell comprising an electrode assembly with infused porous layers described in EXAMPLE 1 compared to the voltage response to various current densities of a prior art electrolyzer cell of Hodges et al. described in COMPARATIVE EXAMPLE 2.

FIG. 9 is a graph of the voltage response to various current densities of the electrolyzer cell comprising an electrode assembly with infused porous layers described in EXAMPLE 1 compared to a similar electrolyzer cell without infused porous layers as described in COMPARATIVE EXAMPLE 4.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1” ” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Hydrogen Production Through Electrolysis

Hydrogen gas (H₂) can be formed electrochemically by a water-splitting reaction where water is split into H₂ gas and (optionally) oxygen gas (O₂) at a cathode and an anode of an electrochemical cell, respectively. Examples of such electrochemical processes include, without limitation, proton electrolyte membrane (PEM) electrolysis and alkaline water electrolysis (AWE). In such electrochemical reactions, the operating energy necessary to drive the water-splitting electrolysis reaction is high due to additional energy costs as a result of various energy inefficiencies. For example, to reduce unwanted migration of ionic species between the electrodes, the cathode and the anode may be separated by a separator, such as a membrane, which can reduce migration of the ionic species. Although the separator can improve the overall efficiency of the cell, it can come at a cost of additional resistive losses in the cell, which in turn increases the operating voltage. Other inefficiencies in water electrolysis can include solution resistance losses, electric conduction inefficiencies, and/or electrode over-potentials, among others.

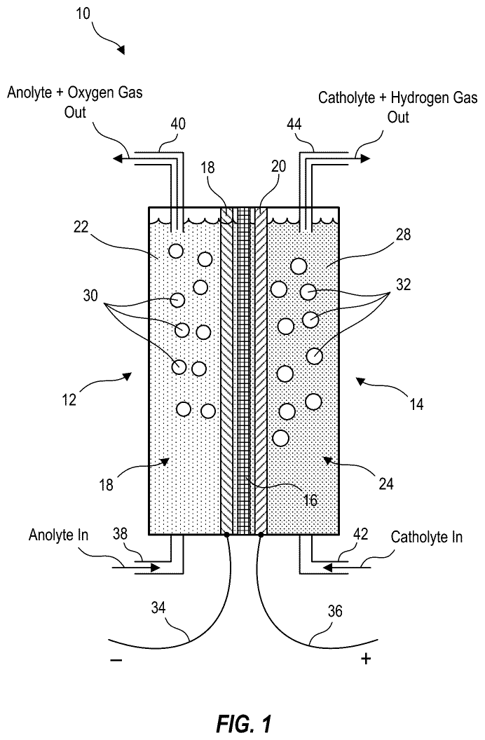

FIG. 1 is a schematic diagram of a conventional water electrolyzer cell 10 that converts water (H₂O) into hydrogen gas (H₂) and oxygen gas (O₂) with electrical power. In an example, the electrolyzer cell 10 comprises a housing 11, e.g., an overall chassis structure that defines and at least partially encloses an interior of the cell 10. The housing 11 can divide the cell 10 into two half cells: a first half cell 12 and a second half cell 14. In an example, the first and second half cells 12, 14 are separated by a separator 16, such as a membrane. In an example, the separator 16 comprises a porous membrane (e.g., a microporous membrane or a nanoporous membrane), an ion-exchange membrane, or an ion solvating membrane. In examples wherein the separator 16 comprises an ion-exchange membrane, the membrane can be of different types, such as an anion exchange membrane (AEM), a cation exchange membrane (CEM), a proton exchange membrane (PEM), or a bipolar ion exchange membrane (BEM). In some examples, depending on the need to restrict or allow migration of a specific cation or an anion species between the electrolytes, the separator 16 may be more restrictive and thus allows migration of one species of ion while restricting the migration of another species of ion. For example, if the separator 16 is a cation exchange membrane (CEM), it can be configured to allow migration of one or more specific species of cations while restricting the migration of one or more other species of cations. Similarly, if the separator 16 is an anion exchange membrane (AEM), it can be more restrictive and thus allow migration of one or more species of anions while restricting the migration of one or more other species of anions.

In some examples, the separator 16 can be selected so that it can function in an acidic and/or an alkaline electrolytic solution, as appropriate. Other properties for the separator 16 that may be desirable include, but are not limited to, high ion selectivity, low ionic resistance, high burst strength, and high stability in electrolytic solution in a temperature range of room temperature to 150° C. or higher. In an example, the separator 16 is stable in a temperature range of from about 0° C. to about 150° C., for example from about 0° C. to about 100° C., such as from about 0° C. to about 90° C., for example from about 0° C. to about 80° C., such as from about 0° C. to about 70° C., for example from about 0° C. to about 60° C., such as from about 0° C., to about 50° C., for example from about 0° C. to about 40° C., or such as from about 0° C. to about 30° C.

In an example, the first half cell 12 defines a first chamber 18 that at least partially houses a first electrode 20 and a first electrolyte solution 22 (also referred to as “the first electrolyte 22”) and the second half cell 14 defines a second chamber 24 that at least partially houses a second electrode 26 and a second electrolyte solution 28 (also referred to as “the second electrolyte 28”). Examples of solutions that can comprise the first electrolyte 22 and the second electrolyte 28 include, but are not limited to, one or more of: a solution of potassium hydroxide (KOH) in water, a solution of sodium hydroxide (NaOH) in water, and a solution of lithium hydroxide (LiOH) in water.

In an example, one or both of the electrodes 20, 26 can be positioned proximate to the separator 16, such as by being abutted against a corresponding face of the separator 16, e.g., with the first electrode 20 being positioned proximate to a first separator face and the second electrode 26 being positioned proximate to a second separator face that opposes the first separator face.

In an example, the first electrode 20 is the anode for the electrolyzer cell 10 and the second electrode 26 is the cathode for the electrolyzer cell 10. Therefore, for the remainder of the present disclosure, the first half cell 12 may also be referred to as “the anode half cell 12,” the first chamber 18 may also be referred to as “the anode chamber 18,” the first electrode 20 may also be referred to as “the anode 20,” the first electrolyte 22 may also be referred to as “the anode electrolyte 22” or “the anolyte 22,” the second half cell 14 may also be referred to as “the cathode half cell 14,” the second chamber 24 may also be referred to as “the cathode chamber 24,” the second electrode 26 may also be referred to as “the cathode 26,” and the second electrolyte 28 may also be referred to as “the cathode electrolyte 28” or “the catholyte 28.” In an example, each electrode 20, 26 can comprise a high surface area metal, such as a fine metal mesh. In an example, each electrode 20, 26 comprises a nickel mesh.

The electrodes 20, 26 are the locations of the cell 10 where electron transfer half reactions occur, e.g., by reacting with one or more components of the electrolyte solutions 22, 28 in the chambers 18, 24 to generate H₂ gas and/or O₂ gas. Each of the electrodes 20, 26 can be coated with one or more electrocatalysts to speed reaction toward H₂ gas and/or toward O₂ gas. In a typical example, one of both of the electrodes 20, 26 comprises a conductive substrate, such as a nickel substrate body, with an electrocatalyst coated onto one or more surfaces of the conductive substrate. One or more binders can be used to adhere an electrocatalyst onto the conductive substrate of one or both of the electrodes 20, 26. In most cases, the electrocatalyst lowers the activation energy for the electrochemical reaction so that the reaction can proceed without the electrocatalyst being consumed by the reaction. By lowering the activation energy, an electrocatalyst is able to facilitate specific reactions at the electrode so that the electrochemical device has a reduced energy demand. Examples of electrocatalyst materials include, but are not limited to, metals, metal alloys, metal-metalloid alloys, metal oxides, metal phosphides, and metal sulfides.

Each of the electrodes 20, 26 can be configured for a particular electrochemical half reaction, such as the half reactions for the overall water electrolysis process described below. For example, the first electrode 20 can be configured to perform a first electrochemical half reaction and the second electrode 26 can be configured to perform a second electrochemical half reaction. The actual half reactions that take place at each electrode 20, 26 can depend on the type of local environment that is present at each electrode 20, 26 during operation of the electrolyzer cell 10, and in particular on the alkalinity (e.g., pH) of the anolyte 22 at the anode 20 and of the catholyte 28 at the cathode 26. Half Reaction [1], below, is an example of a reaction that can take place at the anode 20 when the anolyte 22 is alkaline (e.g., with a pH>7):

4OH⁻→O₂+2 H₂O+4e⁻ [1]

Half Reaction [1] is also referred to as the “Oxygen Evolution Reaction [1]” or “the OER [1].” The O₂ gas that is generated by the OER [1] can form oxygen bubbles 30 in the anolyte 22 within the anode chamber 18, as shown in FIG. 1.

In an example, the pH of the anolyte 22 at the location of the anode 20 (also referred to as “the first local pH” so as to distinguish it from the pH of the catholyte 28) is about 8 or more, for example about 9 or more, such as about 10 or more, for example about 11 or more, such as about 12 or more, for example about 13 or more, such as about 14 or more. In an example, the first local pH of the anolyte 22 is from about 9 to about 15, for example from about 9 to about 14, from about 9 to about 13, from about 9 to about 12, from about 9 to about 11, from about 9 to about 10, from about 10 to about 15, from about 10 to about 14, from about 10 to about 13, from about 10 to about 12, from about 10 to about 11, from about 11 to about 15, from about 11 to about 14, from about 11 to about 13, from about 11 to about 12, from about 12 to about 15, from about 12 to about 14, from about 12 to about 13, from about 13 to about 15, from about 13 to about 14, or from about 14 to about 15.

Half Reaction [2], below, is an example of a reaction that can take place at the cathode 26 when the catholyte 28 is alkaline (e.g., with a pH>7):

2 e⁻+2 H₂O→H₂+2 OH⁻ [2]

Half Reaction [2] is also referred to as the “Hydrogen Evolution Reaction [2]” or “the HER [2].” The H₂ gas that is generated by the HER [2] can form hydrogen bubbles 32 in the catholyte 28 within the cathode chamber 24, as shown in FIG. 1.

In an example, the pH of the catholyte 28 at the location of the cathode 26 (also referred to as “the second local pH” so as to distinguish it from the first local pH of the anolyte 22) is about 8 or more, for example about 9 or more, such as about 10 or more, for example about 11 or more, such as about 12 or more, for example about 13 or more. In an example, the second local pH of the catholyte 28 is from about 8 to about 14, for example from about 8 to about 13, from about 8 to about 12, from about 8 to about 11, from about 8 to about 10, from about 8 to about 9, from about 9 to about 14, from about 9 to about 13, from about 9 to about 12, from about 9 to about 11, from about 9 to about 10, from about 10 to about 14, from about 10 to about 13, from about 10 to about 12, from about 10 to about 11, from about 11 to about 14, from about 11 to about 13, from about 11 to about 12, from about 12 to about 14, from about 12 to about 13, or from about 13 to about 14.

In an example, the anode 20 is electrically connected to an external positive conductive lead 34 (also referred to as “the anode lead 34”) and the cathode 26 is electrically connected to an external negative conductive lead 36 (also referred to as “the cathode lead 36”). In an example, when the separator 16 is wet and is in electrolytic contact with the electrodes 20, 26, and an appropriate voltage is applied across the leads 34 and 36, Half Reactions [1] and [2] are activated. As noted above, in Half Reaction [1], OH⁻ ions are oxidized at the anode 20, which liberates O₂ gas (e.g., as the oxygen bubbles 30 in the anolyte 22) and forms additional H₂O molecules in the anolyte 22. In Half Reaction [2], H₂O is reduced at the cathode 26, which liberates H₂ gas (e.g., as the hydrogen bubbles 32 in the catholyte 28, respectively) and forms additional OH⁻ ions in the catholyte 28. In some examples, at least a portion of the OH⁻ ions pass through the separator 16 (e.g., if the separator 16 is an anion exchange membrane) so that they are available to be oxidized via Half Reaction [1] at the anode 20.

The electrolyzer cell 10 can be configured so that the electrolyte solutions 22, 28 flow through the chambers 18, 24 so that each electrolyte solution 22, 28 can pick up the bubbles of its corresponding gas and carry the produced gas out of the electrolyzer cell 10. For example, the anolyte 22 can flow into the anode half cell 12 through an anolyte inlet 38 and can exit the anode half cell 12 through an anolyte outlet 40. Similarly, the catholyte 28 can flow into the cathode half cell 14 through a catholyte inlet 42 and can exit the cathode half cell 14 through a catholyte outlet 44. In an example, the flow of the anolyte 22 through the anode chamber 18 picks up the produced O₂ gas as the oxygen bubbles 30 and exits the anode chamber 18 through the anolyte outlet 40 and the flow of the catholyte 28 through the cathode chamber 24 picks up the produced H₂ gas as the hydrogen bubbles 32 and exits the cathode chamber 24 through the catholyte outlet 44. One or both of the gases can be separated from the electrolyte solutions 22, 28 downstream of the electrolyzer cell 10 with one or more appropriate separators. In an example, the produced H₂ gas is dried and harvested into high pressure canisters or fed into further process elements. The produced O₂ gas can be allowed to simply vent into the atmosphere or can be stored for other uses. In an example, the electrolyte solutions 22, 28 are recycled back into the half cells 12, 14, as needed.

In an example, a typical voltage across the electrolyzer cell 10 (e.g., the voltage difference between the anode lead 34 and the cathode lead 36) is from about 1.5 volts (V) to about 3.0 V. In an example, an operating current density for the electrolyzer cell 10 is from about 0.1 A/cm² to about 3 A/cm². Each cell 10 has a size that is sufficiently large to produce a sizeable amount of H₂ gas when operating at these current densities. In an example, an active area of each cell 10 (e.g., a width multiplied by a height for a rectangular cell) is from about 0.25 square meters (m²) to about 15 m², such as from about 1 m² to about 5 m², for example from about 2 m² to about 4 m², such as from about 2.25 m² to about 3 m², such as from about 2.5 m² to about 2.9 m². In an example, the total volume of each cell (e.g., a width multiplied by a height multiplied by a depth) is from about 0.1 cubic meter (m³) to about 2 m³, such as from about 0.15 m³ to about 1.5 m³, for example from about 0.2 m³ to about 1 m³, such as from about 0.25 m³ to about 0.5 m³, for example from about 0.275 m³ to about 0.3 m³. In a non-limiting example, the total volume of the entire electrolyzer system (e.g., the combined volume of all the cells in all the stacks in the plant) is from about 1 m³ to about 25,000 m³, such as from about 5 m³ to about 2,500 m³, for example from about 10 m³ to about 100 m³, such as from about 25 m³ to about 75 m³, for example from about 30 m³ to about 50 m³.

### pH Differential

As noted above, maintaining a pH differential across the separator 16 can be beneficial to the overall operation of the electrolyzer cell 10. As used herein, the term “pH differential” refers to the difference between the first local pH of the anolyte 22 at the location of the anode 20 and the second local pH of the catholyte 28 at the location of the cathode 26.

In an example, the second local pH of the catholyte 28 is lower than the first local pH of the anolyte 22 so that there is a pH differential between the first local pH and the second local pH. The theoretical voltage for the entire water electrolysis reaction (i.e., the voltage required for the combination of the Oxygen Evolution Half Reaction [1] at the anode 20 and the Hydrogen Evolution Half Reaction [2] at the cathode 26) is known to be about 1.23 V when there is no pH differential between the electrolyte solutions 22, 28. However, when there is a pH differential such that the second local pH of the catholyte 28 is lower than the first local pH of the anolyte 22, then it has been found that the theoretical voltage required for the entire water electrolysis reaction is defined by Equation [3].

V_{Theoretical}=1.23−0.059×ΔpH [3]

where V_{Theoretical} is the theoretical voltage required to activate Half Reactions [1] and [2], and ΔpH is the difference between the first local pH of the anolyte 22 and the second local pH of the catholyte 28 (i.e., ΔpH=First Local pH—Second Local pH, wherein First Local pH≥Second Local pH). For example, if the first local pH of the anolyte 22 is 15 and the second local pH of the catholyte 28 is 11, then ΔpH=15-11=4, which results in the electrolyzer cell 10 having a theoretical water electrolysis potential, V_{Theoretical}, of 0.994 V, which is 0.236 V less than the 1.23 V theoretical potential for a cell with no pH differential. In other words, the voltage that is required to drive the water electrolysis Half Reactions [1] and [2] when the first local pH is 15 and the second local pH is 11 can be as much as about 19.2% lower than the voltage that is required when the first local pH and the second local pH are the same ((1.23-0.994)/1.23≈0.1919).

In an example, the difference between the first local pH of the anolyte 22 and the second local pH of the catholyte 28 is 1 or more, such as 1.1 or more, 1.2 or more, 1.25 or more, 1.3 or more, 1.4 or more, 1.5 or more, 1.6 or more, 1.75 or more, 1.8 or more, 1.9 or more, 2 or more, 2.1 or more, 2.2 or more, 2.25 or more, 2.3 or more, 2.4 or more, 2.5 or more, 2.6 or more, 2.75 or more, 2.8 or more, 2.9 or more, 3 or more, 3.1 or more, 3.2 or more, 3.25 or more, 3.3 or more, 3.4 or more, 3.5 or more, 3.6 or more, 3.75 or more, 3.8 or more, 3.9 or more, 4 or more, 4.1 or more, 4.2 or more, 4.25 or more, 4.3 or more, 4.4 or more, 4.5 or more, 4.6 or more, 4.75 or more, 4.8 or more, 4.9 or more, 5 or more, 5.1 or more, 5.2 or more, 5.25 or more, 5.3 or more, 5.4 or more, 5.5 or more, 5.6 or more, 5.75 or more, 5.8 or more, 5.9 or more, 6 or more, 6.1 or more, 6.2 or more, 6.25 or more, 6.3 or more, 6.4 or more, 6.5 or more, 6.6 or more, 6.75 or more, 6.8 or more, 6.9 or more, such as about 7 or more. In an example, the pH differential between the first local pH of the anolyte 22 and the second local pH of the catholyte 28 is from about 1 to about 7, for example from about 1 to about 6, from about 1 to about 5, from about 1 to about 4, from about 1 to about 3, from about 1 to about 2, from about 2 to about 7, from about 2 to about 6, from about 2 to about 5, from about 2 to about 4, from about 2 to about 3, from about 3 to about 7, from about 3 to about 6, from about 3 to about 5, from about 3 to about 4, from about 4 to about 7, from about 4 to about 6, from about 4 to about 5, from about 5 to about 7, from about 5 to about 6, or from about 6 to about 7.

In an example, a balance between the electrical conductivity and the second local pH of the catholyte 28 is maintained such that the second local pH of the catholyte 28 is lower than the first local pH of the anolyte 22 and such that the catholyte 28 has an electrical conductivity that does not adversely affect the cell voltage owing to a large resistance across the electrolyzer cell 10. In an example, to achieve this goal, the catholyte 28 includes a salt comprising a polyatomic anion. The term “polyatomic anion,” used herein, includes a covalently bonded set of two or more atoms that has a non-zero net charge. Examples of polyatomic anion salts that can be added to the catholyte 28 include, but are not limited to, a carbonate, a citrate, an oxalate, ethylene diamine tetraacetic acid (EDTA), a malate, an acetate, a phosphate, a sulfate, or combinations thereof. In an example, the salt comprising polyatomic anion includes a cation, wherein the cation is selected from the group consisting of lithium, sodium, potassium, rubidium, cesium, or the like, and combinations thereof.

In an example, the aforementioned salt comprises cations and the polyatomic anion is selected such that the salt is stable and soluble in alkaline conditions (i.e., pH>7) and possesses one or more properties, such as, but not limited to, not blocking the transport mechanism of the separator 16, not migrating through the separator 16, not reacting at the cathode 26, and/or not reacting with OH⁻ ions, H₂ gas, or O₂ gas. In an example, the polyatomic anion is such that the anion is selectively rejected by the separator 16 (if the separator 16 is an anion exchange membrane) so that only or substantially only OH⁻ ions are transported across the separator 16 from the cathode chamber 24 to the anode chamber 18 to maintain a pH differential. In an example, the polyatomic anion may also be selected such that its anion is stable in a reducing environment so that water is reduced at the cathode 26 instead of the polyatomic anion. In an example, the corresponding cation in the salt comprising the polyatomic anion is selected such that the cation does not pass through the separator 16 from the cathode chamber 24 to the anode chamber 18 and is not reduced at the cathode 26.

In an example, a concentration of the salt comprising the polyatomic anion within the catholyte 28 is from about 0.1 M to about 3 M, for example from about 0.1 M to about 2.5 M, such as from about 0.1 M to about 2 M, for example from about 0.1 M to about 1.5 M, such as from about 0.1 M to about 1 M, for example from about 0.1 M to about 0.5 M, such as from about 0.5 M to about 3 M, for example from about 0.5 M to about 2.5 M, such as from about 0.5 M to about 2 M, for example from about 0.5 M to about 1.5 M, such as from about 0.5 M to about 1 M, for example from about 1 M to about 3 M, such as from about 1 M to about 2.5 M, for example from about 1 M to about 2 M, such as from about 1 M to about 1.5 M, for example from about 1.5 M to about 3 M, such as from about 1.5 M to about 2.5 M, for example from about 1.5 M to about 2 M, such as from about 2 M to about 3 M, for example from about 2 M to about 2.5 M.

When a pH differential exists across a separator or membrane, like the separator 16 in the electrolyzer cell 10, the pH differential will tend to equilibrate over time. For example, in the electrolyzer cell 10 of FIG. 1 when the anolyte 22 and the catholyte 28 are alkaline (e.g., with a pH>7), then the OER [1] occurs at the anode 20 and the HER [2] occurs at the cathode 26. In the OER [1], hydroxide ions (OH⁻) in the anolyte 22 are oxidized to form O₂ gas and water molecules (H₂O). As OH⁻ ions are consumed from the anolyte 22 by the OER [1], the concentration of OH⁻ ions in the anolyte 22 will drop. Unless the OH⁻ ions consumed from the anolyte 22 are replenished, the first local pH of the anolyte 22 will drop. In the HER [2], H₂O in the catholyte 28 is reduced to form H₂ gas and OH⁻ ions. As the OH⁻ ions are produced in the catholyte 28, the concentration of OH⁻ ions in the catholyte 28 will increase. Unless the OH⁻ ions added to the catholyte 28 are neutralized or reduced, the second local pH of the catholyte 28 will rise. The combination of the first local pH of the anolyte 22 dropping as O₂ gas is produced at the anode 20 and the second local pH of the catholyte 28 rising as H₂ gas is produced at the cathode 26 will tend to cause the higher first local pH and the lower second local pH to move toward each other. This effect can be alleviated somewhat if the separator 16 is configured so that OH⁻ ions generated by the HER [2] into the catholyte 28 can pass through the separator 16 (e.g., if the separator 16 is an anion exchange membrane or a nanoporous membrane through which the OH⁻ ions can pass), but usually the transfer of OH⁻ ions through the separator 16 is not sufficient to counteract the tendency for the pH differential to equilibrate over time.

Therefore, in order to maintain a desired pH differential between the anolyte 22 and the catholyte 28, it is often necessary to add additional energy to the system in some form to maintain the differential. One prior system of maintaining a pH differential included using an alkaline anolyte (e.g., a KOH solution) and a neutral catholyte (e.g., nominally pure water) at startup of an electrolyzer cell with a cation exchange membrane (CEM) that allowed K⁺ ions to be transported through the CEM. The hydrogen evolution reaction resulted in accumulation of KOH at the cathode over time. In order to prevent the catholyte pH from raising over time, water was added to the catholyte to “wash” the KOH, such as by adding water evaporated from the anolyte or another “wash solution” to the catholyte over time. The catholyte “washing” system comprising a CEM was described in Teschke, “Theory and operation of a steady-state pH differential water electrolysis cell,” J. Applied Electrochemistry, Vol. 12 (1982), pp. 219-23 (hereinafter “Teschke I”) and in Teschke et al., “Operation of a Steady-State pH-Differential Water Electrolysis Cell, Int. J. Hydrogen Energy, Vol. 7 (1982), pp. 933-37 (hereinafter “Teschke II”) (collectively “the Teschke System”).

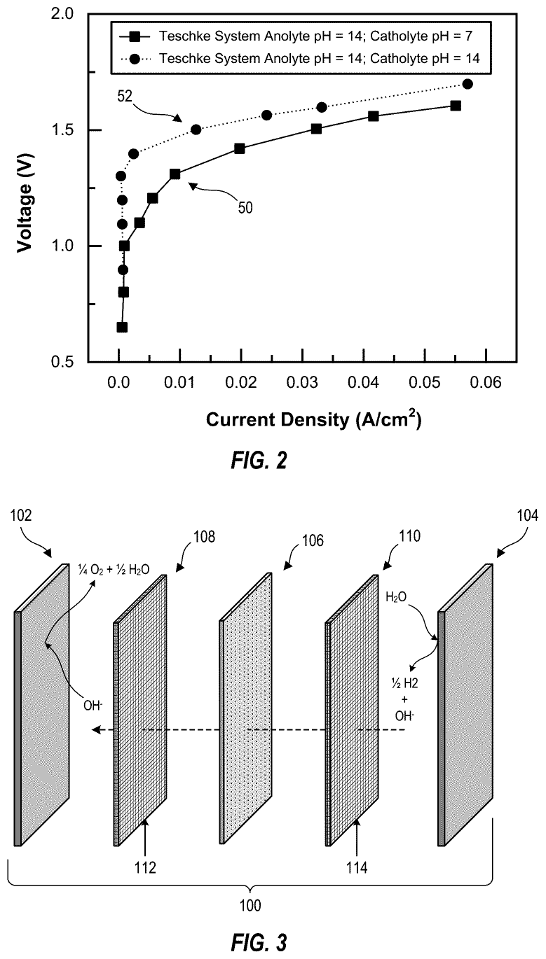

The Teschke System, and others like it, can provide for water electrolysis, but they typically do not perform at a high efficiency, often due to poor cell resistance. As used herein, the term “cell resistance” refers to the voltage required for a given current density. For example, FIG. 2 shows the voltage response for the Teschke System while operating at a pH differential of 7 (i.e., with the anolyte pH at 14 and the catholyte pH at 7-squares, data series 50) compared to the same system while operating with no pH differential (i.e., with both the anolyte and the catholyte at a pH of 14-circles, data series 52). As can be seen in FIG. 2, the Teschke System with a pH differential (data series 50) shows an improvement compared to the same system without a pH differential (data series 52), as indicated by the slight flattening of the curve for data series 50 versus data series 52, indicating a slightly lower cell resistance. However, the CEM in the Teschke System allows a large majority of its ionic current (e.g., around 99% or more) to be in the form of cations (K⁺ ions) moving from the anolyte to the catholyte. As used herein, the term “ionic current” refers to the “flow” of charge from one point in an electrolyzer cell to another point in the electrolyzer cell (often across an ion-exchange membrane or other separator), in order to distinguish that movement of charge from “electrical current,” which is the “flow” of charge via the transfer of electrons through a conductive material (such as the leads 34, 36 or the electrodes 20, 26 in the electrolyzer cell 10 of FIG. 1).

The large majority of the ionic current in the Teschke System being via the transfer of K⁺ ions through its CEM means that a large amount of OH⁻ ions will accumulate in the catholyte, and those OH⁻ ions must be rebalanced to maintain a pH differential long term. Moreover, even with the improved performance of the system with the pH differential (data series 50) compared to the system where both sides of the cell are operated at the same pH (data series 52), the Teschke system still exhibits a very high cell resistance and an undesirable curvature of the voltage-current density curve in the range of from about 0.02 A/cm² to about 0.05 A/cm².

### Assembly Comprising Electrodes, Separator, and One or More Solution Infused Layers

The present disclosure describes a novel architecture for an electrolyzer cell that provides that can provide for easier maintenance of a pH differential across a separator, among other benefits. FIG. 3 is an exploded perspective view of an example separator, electrode, and porous layer assembly 100 (also referred to hereinafter as “electrode assembly 100” or simply “assembly 100” for brevity) that can be used within an electrolyzer cell (described in more detail below)). As described in more detail below, the electrode assembly 100 includes one or more liquid or solution holding layers that can each be infused with a specified solution to provide for a specified local environment at one or both of the electrodes of an electrolyzer cell. The presence of the specified solution in or on the liquid or solution holding can ensure that the local pH environment at its corresponding electrode is at a desired pH for that electrode, which can ease maintenance of a pH differential with a lower energy input requirement and a simpler system compared to prior art methods such as the Teschke System.

As shown in FIG. 3, the example electrode assembly 100 includes a first electrode 102, a second electrode 104, and a separator 106 positioned between the first and second electrodes 102, 104, i.e., to separate the anode chamber from the cathode chamber in the cell in which the electrode assembly 100 is located. In an example, the first electrode 102 is the anode of the assembly 100 and the second electrode 104 is the cathode, such that the first electrode 102 will also be referred to as “the anode 102” and the second electrode 104 will be referred to as the cathode 104. In some examples, one or both of the anode 102 and the cathode 104 can comprise a structure having a relatively high surface area, such as a fine metal mesh. Fine metal meshes have been found to make excellent electrodes for electrolyzer cells because they provide a high relative surface area for the Half Reaction [1] or [2] to take place, can have a relatively large open area for electrolyte and gas to flow to and from the electrode, and are readily available in sizes that are sufficiently large for commercial electrolyzer systems (e.g., in cells with an active area of at least 1 square meter (m²), such as from about 1 m² to about 4 m² per electrolyzer cell). In some examples, a fine metal mesh that can be used as one or both of the electrodes 102, 104 can comprise a network of sets of crossing wires, which can be perpendicular or angled relative to one another, that alternative cross and bend over one another. For example, any particular wire alternates between passing under an adjacent cross wire and then over the next cross wire. Various types of weave patterns can be used for a woven mesh including, but not limited to: as a plain weave, a plain/double weave, a plain Dutch weave pattern, a reverse plain Dutch weave pattern, a twill weave pattern (e.g., a twill square weave pattern or a twill Dutch weave pattern), a reverse twill weave pattern, a twill Dutch double weave pattern, and a stranded weave pattern.

Another example for one or both of the electrodes 102, 104 is an expanded metal mesh fabricated from a sheet of metal to form an expanded metal body that can be very thin (e.g., about 0.5 mm or less, such as about 0.25 mm or less, for example about 0.2 mm or less, such as about 0.15 mm or less, such as about 0.145 mm, about 0.14 mm, about 0.135 mm, about 0.13 mm, about 0.125 mm, about 0.12 mm, about 0.115 mm, about 0.11 mm, about 0.105 mm, or about 0.1 mm or less) with relatively large openings (e.g., with diamond-shaped openings having long way of the diamond shape (LWD) of about 1 mm or more, such as about 2 mm or more, and a short way of the diamond shape (SWD) of about 0.5 mm or more, such as about 1 mm or more.

One or both of the electrodes 102, 104 can be coated with an electrocatalyst material, such as particles of electrocatalyst that are coated or otherwise bound to one or more surfaces of one or both electrodes 102, 104. In an example, the electrocatalyst material (such as particles of electrocatalyst material) (if present on a particular electrode 102, 104) can be adhered to the substrate body of the electrode 102, 104 with a binder.

In an example, one or both of the electrodes 102, 104 comprises an ionomer, which has been found to improve overall cell resistance. The use of an ionomer was found to be particularly beneficial in the cathode 104 when the catholyte solution has a low conductivity, such as when the catholyte is pure water or is a low-concentration electrolyte (e.g., low concentration KOH) solution. In an example, the cathode comprises an electrode substrate coated with a catalyst coating. In an example, the catalyst coating comprises particles of electrocatalyst material that is bound to the electrode substrate with a binder comprising the ionomer. In an example, an ionomer materials can be used as part of one or both of the electrodes 102, 104 include, such as in a binder to bind electrocatalyst particles to the electrode substrate, include. Examples of ionomers that can be used for as a binder in one or both electrodes 102, 104, or incorporated into one or both electrodes 102, 104 in some other way, include but are not limited to, a fluoropolymer-based polymer with one or more ionic group modifications, such as ionic-modified polytetrafluoroethylene (PTFE). A commercial example of such an ionomer material that can be used as a binder include those sold under the NAFION™ trade name by The Chemours Co., Wilmington, DE, USA, which is a PTFE copolymer with perfluorovinyl ether and sulfonate groups modifying some of the tetrafluoroethylene base groups on the PTFE backbone.

The separator 106 can be similar or identical to the separator 16 described above for the electrolyzer cell 10 of FIG. 1. For example, the separator 106 can comprise a porous membrane (e.g., a microporous membrane or a nanoporous membrane), an ion-exchange membrane, or an ion solvating membrane. In examples wherein the separator 106 comprises an ion-exchange membrane, the membrane can be of different types, such as an anion exchange membrane (AEM), a cation exchange membrane (CEM), a proton exchange membrane (PEM), or a bipolar ion exchange membrane (BEM).

In a preferred example, the separator 106 is an anion exchange membrane that is configured to allow the passage of anions more freely, and in particular OH⁻ anions, as compared to the passage of cations, such as K⁺ cations. For example, the separator 106 can be an anion exchange membrane (AEM) that is configured specifically to allow the relatively free passage of OH⁻ anions (e.g., from the cathode side to the anode side of the separator 106) and that blocks or substantially blocks passage of K⁺ cations (e.g., to prevent or reduce the passage of K⁺ cations from the anode side to the cathode side of the separator 106). When the separator 106 is an AEM, it can allow OH⁻ ions on the cathode side of the separator 106 (e.g., OH⁻ ions that are present in the catholyte solution and/or OH⁻ ions that are produced by the Hydrogen Evolution Reaction [2]) to carry a substantial portion of the ionic current that flows across the separator 106, and in preferred examples a majority of the ionic current, for example at least about 90% of the ionic current, at least about 91%, at least about 91.5%, at least about 92%, at least about 92.5%, at least about 93%, at least about 93.5%, at least about 94%, at least about 94.5%, at least about 95%, at least about 95.5%, at least about 96%, at least about 96.5%, at least about 97%, at least about 97.5%, at least about 98%, at least about 98.1%, at least about 98.2%, at least about 98.25%, at least about 98.3%, at least about 98.4%, at least about 98.5%, at least about 98.6%, at least about 98.7%, at least about 98.75%, at least about 98.8%, at least about 98.9%, at least about 99%, at least about 99.1%, at least about 99.2%, at least about 99.25%, at least about 99.3%, at least about 99.4%, at least about 99.5%, at least about 99.6%, at least about 99.7%, at least about 99.75%, at least about 99.8%, at least about 99.85%, at least about 99.9%, at least about 99.91%, at least about 99.92%, at least about 99.93%, at least about 99.94%, at least about 99.95%, at least about 99.96%, at least about 99.97%, at least about 99.98%, at least about 99.99% of the ionic current. Also, an AEM can transfer the produced OH⁻ ions to the anolyte where they are needed for the Oxygen Evolution Reaction [1]. Thus, an AEM can reduce the need for a material balance because a smaller amount of OH⁻ ions (or KOH) accumulates on the cathode side of the separator 106 awaiting rebalancing and return to the anolyte.

Non-limiting examples of AEMs that can be used as the separator 106 in the electrode assembly 100 are the AEMs sold under the FUMASEP™ trade name by Fumatech BWT GmbH, Bietigheim-Bissingen, Germany that can be used as an AEM in a water electrolyzer cell, such as the FUMASEP™ FAA-3-20 membrane, the FUMASEP™ FAA-2-20 membrane, the FUMASEP™ FAAM-20 membrane, and the FUMASEP™ FAAM-PK-75 membrane. Because an AEM is a preferred type of separator for use in the electrode assembly 100 that includes the liquid or solution holding layers (described in more detail below), the separator 106 will also be referred to as “the AEM 106” for the sake of brevity. However, even though the separator 106 will also be referred to as the AEM 106, those having skill in the art will appreciate that it may not be necessary for the separator 106 to be an AEM if the separator 106 is able to have transport properties that are useful for the electrode assembly 100 and for the electrolyzer cell as a whole. For example, rather than a strictly AEM material, the separator 106 can be made from a porous separator material that does not have ion exchange capacity, but that can still provide some material balance benefit and adequate cell resistance and durability, such as the separator material sold under the ZIRFON™ trade name by Agfa-Gevaert N.V., Mortsel, Belgium, such as the separator membrane sold under the ZIRFON™ PERL UTP 500 trade name.

The electrode assembly 100 also includes at least one layer that is capable of holding a liquid or an aqueous solution, wherein the solution holding layer is positioned adjacent to a corresponding one of the electrodes 102, 104. For example, the electrode assembly 100 can include one or both of a first solution holding layer 108 positioned adjacent to the anode 102 and a second solution holding layer 110 positioned adjacent to the cathode 104. In an example, each of the one or more layers 108, 110 that are included in the electrode assembly 100 comprise a material that is able to be infused with a specified solution (such as an aqueous solution).

The term “solution,” as used herein when referring to the specified solution that is infused into or onto a solution holding layer 108, 110, can be any liquid or solution phase composition that will provide for a specified effect for the electrode 102, 104 to which the particular porous layer 108, 110 is adjacent. For example, a “specified solution” could be pure water (H₂O) or another liquid that does not include a solute therein, so that the “specified solution” may not be a “solution” in the strict, chemistry sense of the word, but will nevertheless be considered a “specified solution” for the purposes of the present disclosure.

The terms “infuse,” “infusing,” “infused,” “infusible” and the like, as used herein when referring to the one or more solution holding layers 108, 110 described herein, refer to inclusion of a specified solution so that the specified solution is held on the surfaces of or within a matrix of the material of the particular layer 108, 110 into or onto which the specified solution is infused. Examples of physical or chemical processes that can be considered “infusing” the layer 108, 110 with the specified solution for the purposes of the present disclosure include, but are not limited to: soaking the layer 108, 110 with the specified solution; coating one or more surfaces of a material of the layer 108, 110 with the specified solution; wicking of the specified solution into or onto a material or matrix of the layer 108, 110 (e.g., by immersing a portion of the layer 108, 110 in the specified solution so that the specified solution can move into the material or matrix of the layer 108, 110, such as via spontaneous capillary action); impregnating a material or matrix of the layer 108, 110 with the specified solution; sorption of the specified solution into or onto a material or matrix of the layer 108, 110 (e.g., absorption of the specified solution into a matrix or material of the layer 108, 110 and/or adsorption of the specified solution onto one or more surfaces of the layer 108, 110); diffusing the specified solution into a material of the layer 108, 110; and permeating the specified solution into a material of the layer 108, 110.

Each solution holding layer 108, 110 can comprise one or more materials that are capable of being infused with the specified solution for that particular layer 108, 110. Examples of materials that can be used to form at least a portion of each solution holding layer 108, 110 include, but are not limited to: paper or paper-based materials (e.g., one or more sheets of material made from a fibrous base, such as pulped wood or other plant material or from artificial fibers); woven fibrous liquid-infusible structures; non-woven fibrous liquid-infusible structures; and foamed materials (such as sponges or sponge-like absorbent foams). While the material or materials of the one or more solution holding layers 108, 110 must be able to be infused by the specified solution, the material or materials should not have such a strong affinity for the compound or compounds of interest in the specified solution (such as OH⁻ ions or H₂O) that the compound or compounds of interest will be able to be released from the one or more solution holding layers 108, 110 in order for the compound or compounds of interest to be available to the specified electrode 102, 104. In short, the material or materials of the one or more solution holding layers 108, 110 should have enough affinity for the specified solution so that the solution holding layer 108, 110 will be at least partially infused with the specified solution, but not so high of an affinity that the specified solution becomes bound with the solution holding layer 108, 110 to such an extent that the specified solution will not be sufficiently available to the electrode 102, 104 that corresponds to the solution holding layer 108, 110.

In many examples, the types of materials that can be used to form the one or more solution holding layers 108, 110 and infused with the specified solution (including the example materials listed above) are porous or have a matrix-like structure that includes open pore-like spaces into which the specified solution can be infused and held. Therefore, for the sake of brevity and simplicity, the solution holding layers 108 110 will also be referred as “the porous layers 108, 110.” Those having skill in the art will appreciate, however, that a material used to form one or more of the layers 108, 110 need not actually include pores or be “porous,” so long as the material is able to be infused with the specified solution and so long as the specified solution will be available to the corresponding electrode 102, 104, e.g., to provide for the specified local pH environment at the corresponding electrode 102, 104.

In an example, each porous layer 108, 110 that is present as part of the electrode assembly 100 can be infused with its own specified solution. For example, the anode-side porous layer 108, if present, can be infused with a first specified solution 112 and/or the cathode-side porous layer 110, if present, can be infused with a second specified solution 114. In an example, the electrolyzer cell of which the electrode assembly 100 is a part can include one or more structures for continually or periodically feeding a specified solution 112, 114 to its corresponding porous layer 108, 110, such as a solution inlet that is configured to feed the specified solution 112, 114 to the corresponding porous layer 108, 110 to ensure a sufficient supply of the specified solution 112, 114 to its corresponding porous layer 108, 110 during operation of the cell of which the assembly 100 is a part.

In an example, the one or more specified solutions 112, 114 that are infused into or onto the one or more porous layers 108, 110 are selected to ensure delivery of one or more reactants to the electrode 102, 104 corresponding to the particular porous layer 108, 110. For example, as noted above, the reactant for the Oxygen Evolution Reaction [1] is hydroxide (OH⁻) ions, which are oxidized at the anode 102 to form O₂ gas and water (H₂O) molecules, which is shown conceptually in FIG. 3. Therefore, if the assembly 100 includes the anode-side porous layer 108, then the first specified solution 112 that is infused into or onto the anode-side porous layer 108 can comprise a relatively high concentration of OH⁻ ions (such as a relatively concentrated KOH solution) to ensure an adequate supply of OH⁻ ions to the anode 102. Similarly, as noted above, the reactant for the Hydrogen Evolution Reaction [2] is H₂O, which is reduced at the cathode 104 to form H₂ gas and OH⁻ ions, which is also shown conceptually in FIG. 3. Therefore, if the electrode assembly 100 includes the cathode-side porous layer 110, then the second specified solution 114 that is infused into or onto the cathode-side porous layer 110 can comprise a relatively high concentration of H₂O (such as pure water). Alternatively, the second specified solution 114 that is infused into or onto the cathode-side porous layer 110 can be a solution comprising OH⁻ ions (e.g., a KOH solution), but with a lower concentration of OH⁻ ions than the first specified solution 112 for the anode-side porous layer 108.

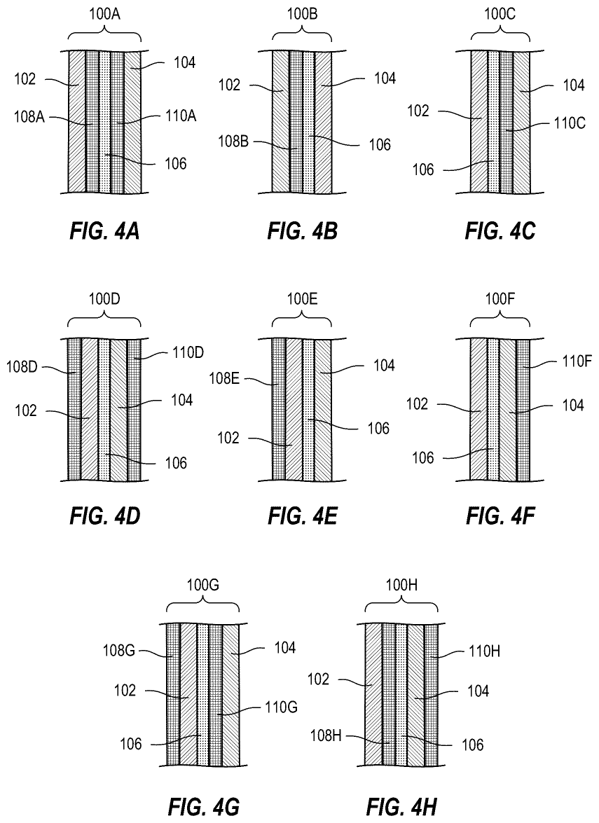

As mentioned above, each of the one or more porous layers 108, 110 can be positioned adjacent to a corresponding electrode 102, 104. In the example assembly 100 shown in FIG. 3, each porous layer 108, 110 is positioned between its corresponding electrode 102, 104 and the AEM 106 so that the specified solution 112, 114 will be available to the side of the corresponding electrode 102, 104 that is closest to the AEM 106. FIGS. 4A-4H show cross-sectional views of several example electrode assemblies 100 that each include some combination of one or more porous layers 108, 110 at various different positions relative to the anode 102, the cathode 104, and the AEM 106. For the sake of clarity, the position of each porous layer 108, 110 will be referred to relative to the side of its corresponding electrode 102, 104 that the porous layer 108, 110 is adjacent to. The side of each electrode 102, 104 that is facing the AEM 106 will be referred to as “the proximal side” of the electrode 102, 104, while the side of each electrode 102, 104 that is facing away from the AEM 106 (e.g., opposite to the proximal side) will be referred to as “the distal side” or “the opposing side.”

FIGS. 4A-4C show example electrode assemblies 100A, 100B, 100C wherein each porous layer that is present is positioned between its corresponding electrode 102, 104 and the AEM 106, e.g., so that the specified solution of the porous layer will be available to the proximal side of its corresponding electrode 102, 104. The electrode assembly 100A of FIG. 4A is substantially identical to the example electrode assembly 100 shown in FIG. 3, i.e., with an anode-side porous layer 108A located adjacent to the proximal side of the anode 102 and a cathode-side porous layer 110A located adjacent to the proximal side of the cathode 104 so that the anode-side porous layer 108A is between the anode 102 and the AEM 106 and the cathode-side porous layer 110 is between the cathode 104 and the AEM 106. FIG. 4B shows an example electrode assembly 100B that only includes an anode-side porous layer 108B adjacent to the proximal side of the anode 102 between the anode 102 and the AEM 106, such that a cathode-side porous layer is omitted. Conversely, FIG. 4C shows an example electrode assembly 100C that only includes a cathode-side porous layer 110C located adjacent to the proximal side of the cathode 104 between the cathode 104 and the AEM 106, such that an anode-side porous layer is omitted.

FIGS. 4D-4F show example electrode assemblies 100D, 100E, 100F wherein each porous layer that is present is positioned adjacent to the opposing side of its corresponding electrode 102, 104, e.g., so that the specified solution of the porous layer is available to the opposing side of the corresponding electrode 102, 104. FIG. 4D shows an example electrode assembly 100D that is similar to the electrode assembly 100A of FIG. 4D in that the electrode assembly 100D includes both an anode-side porous layer 108D and a cathode-side porous layer 110D, but with the anode-side porous layer 108D positioned adjacent to the opposing side of the anode 102 and with the cathode-side porous layer 110D positioned adjacent the opposing side of the cathode 104 and with the anode 102 and cathode 104 each being directly adjacent to the AEM 106. FIG. 4E shows an electrode assembly 100E that is similar to the electrode assembly 100B of FIG. 4B with only an anode-side porous layer 108E and with a cathode-side porous layer omitted, but with the anode-side porous layer 108 positioned adjacent to the opposing side of the anode 102 instead of the proximal side of the anode 102. FIG. 4F shows an electrode assembly 100F that is similar to the electrode assembly 100C of FIG. 4C with only a cathode-side porous layer 110F and with an anode-side porous layer omitted, but with the cathode-side porous layer 110F positioned adjacent to the opposing side of the cathode 104 instead of the proximal side of the cathode 104.

FIGS. 4G and 4H show example electrode assemblies 100G and 100H that each include both anode and cathode-side porous layers, but with the two porous layers located on different sides of their corresponding electrodes 102, 104. FIG. 4G shows an example electrode assembly 100G wherein an anode-side porous layer 108G is located adjacent to the opposing side of the anode 102 and a cathode-side porous layer 110G is located adjacent to the proximal side of the cathode 104. FIG. 4H shows an example electrode assembly 100H that is the opposite, e.g., with an anode-side porous layer 108H located adjacent to the proximal side of the anode 102 and a cathode-side porous layer 110H that is located adjacent to the opposing side of the cathode 104.

In electrode assemblies 100 wherein one or more of the porous layers 108, 110 are located adjacent to the opposing side of its corresponding electrode 102, 104 (e.g., the anode-side porous layers 108D, 108E, and 108G and the cathode-side porous layers 110D, 110F, and 110H), then it may be advantageous for one or both of the electrodes 102, 104 to have an open structure so that one or more compounds and/or the specified solutions 112, 114 may be able to pass from the opposing side of the electrode 102, 104 to the proximal side of the electrode 102, 104 so that the one or more compounds and/or the specified solution 112, 114 may come into contact with the AEM 106 and either be transferred to the other side of the AEM 106 (in the case of the one or more compounds) or can receive one or more compounds that have been transferred from the other side of the AEM 106. For example, it may be desirable for one or both of the anode 102 and the cathode 104 to have an open structure so that OH⁻ ions that are formed via the Hydrogen Evolution Reaction [2] at the cathode 104 (which may occur on the opposing side of the cathode 104 because that is where the cathode-side porous layer 110D, 110F, 110H is located) to pass through the cathode 104 so that the OH⁻ ions can be transferred through the AEM 106. In some examples, the OH⁻ ions that are transferred through the AEM 106 from the cathode side may also pass through the open structure of the anode 102 so that the OH⁻ ions can be received by the first specified solution 112 of the anode-side porous layer 108D, 108E, 108G. An example of an open structure that one or both of the electrodes 102, 104 may include can be a mesh structure, such as a mesh formed from a plurality of woven or non-woven conductive wires with mesh openings that can collectively act as an electrode.

Electrolyzer Cell with Porous Layer Assembly

Because the one or more porous layers 108, 110 of the electrode assembly 100 can deliver sufficient reactants to one or both of the electrodes 102, 104, the inclusion of the one or more porous layers 108, 110 can enable an electrolyzer cell wherein one or both of the anode chamber for receiving anolyte solution (e.g., the anode chamber 18 in the electrolyzer cell 10 of FIG. 1) and the cathode chamber for receiving catholyte solution (e.g., the cathode chamber 24 in the electrolyzer cell 10) can be left out of the cell and replaced with a gas collecting chamber or other structure for collecting or receiving the gas generated by the corresponding electrode 102, 104 (e.g., an O₂ collecting or receiving chamber or other structure if the cell includes an anode-side porous layer and/or a H₂ collecting or receiving chamber or other structure if the cell includes a cathode-side porous layer).

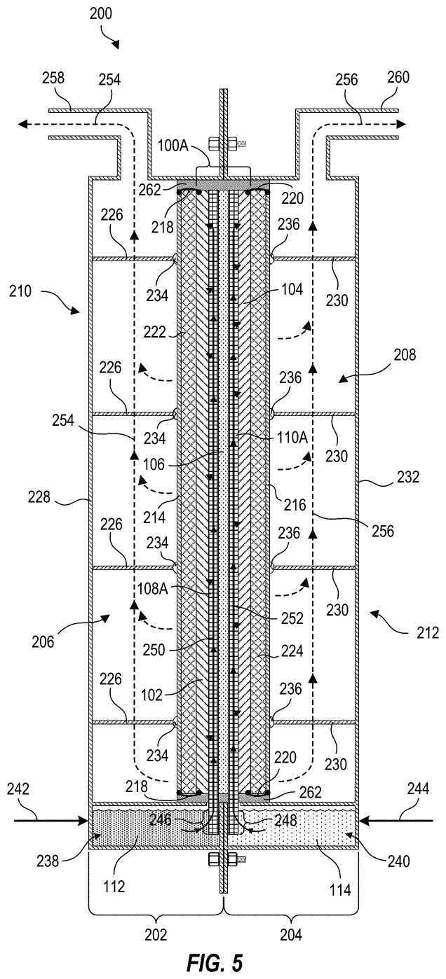

FIG. 5 shows a cross-sectional view of an example electrolyzer cell 200 that incorporates an electrode assembly 100 comprising the one or more porous layers 108, 110 infused with a corresponding specified solution. In the configuration shown in FIG. 5, the electrolyzer cell 200 includes the example assembly 100A shown in FIG. 4A, and FIG. 5 will be described in reference to this example configuration of the electrode assembly 100A. Those having skill in the art will appreciate that the electrolyzer cell 200 could incorporate one of the other configurations of the electrode assembly 100 (e.g., the configuration of one of the electrode assemblies 100B-100H shown in FIGS. 4B-4H, or a different configuration entirely) without varying from the scope of the present disclosure.

In an example, the electrolyzer cell 200 includes a housing structure to enclose a cell interior. In an example, the housing structure of the electrolyzer cell 200 comprises pan assemblies 202, 204 that collectively enclose the cell interior. The pan assemblies 202, 204 define and enclose two half cells (similar to the half cells 12, 14 described above for the electrolyzer cell 10 of FIG. 1). For example, a first pan assembly 202 can at least partially enclose the anode 102 to define an anode half cell, and a second pan assembly 204 can at least partially enclose the cathode 104 to define a cathode half cell. Therefore, the first pan assembly 202 will also be referred to herein as “the anode pan assembly 202” and the second pan assembly 204 will be referred to herein as “the cathode pan assembly 204,” and other aspects of each half cell may be referred to herein as the “anode-side” or the “cathode-side” of the electrolyzer cell 200. However, those having skill in the art will appreciate that the specific orientation of the anode half cell and the cathode half cell shown and described herein are not limiting and are merely provided for convenience of description. In addition, there are instances when the anode pan assembly 202 and/or the cathode pan assembly 204 are referred to more generically as “the pan assemblies 202, 204” or “the pan assembly 202, 204.”

The separator 106 is situated between the anode half cell and the cathode half cell, specifically by being located between the anode 102 and the cathode 104 so that the separator 106 divides an interior chamber 206 of the anode pan assembly 202 from an interior chamber 208 of the cathode pan assembly 204. In an example, each pan assembly 202, 204 includes a pan that defines the interior chamber 206, 208. For example, the anode pan assembly 202 can include an anode pan 62 that at least partially surrounds the anode-side chamber 206 and the cathode pan assembly 204 can include a cathode pan 212 that at least partially surrounds the cathode-side chamber 208.

Each electrode can be electrically connected to its corresponding pan so that electrical current can flow from the pan to the electrode (as is the case for current flowing from the anode pan 210 to the anode 102) or from the electrode to the pan (as is the case for current flowing from the cathode 104 to the cathode pan 212). Each half cell can include one or more additional structures to provide for the electrical connection between the electrode 102, 104 and its corresponding pan 210, 212. In an example, one or both of the pan assemblies 202, 204 includes a conductive support member that can be electrically connected to a corresponding pan 210, 212, and each electrode 102, 104 can also be electrically coupled to its corresponding support member, either directly or indirectly. For example, the anode pan assembly 202 can include an anode-side support member 214 that is electrically connected to the anode pan 210 and a cathode-side support member 216 that is electrically connected to the cathode pan 212. Examples of the support member 214, 216 include a metal support plate or an expanded metal mesh.

In an example, one or both of the support members 214, 216 are configured to distribute current to the corresponding electrode (in the case of the anode-side support member 214 and the anode 102) or to collect current from the corresponding electrode (in the case of the cathode-side support member 216 and the cathode 104). A structure that collects or distributes current within an electrolyzer cell is often referred to as a “current collector.” Therefore, for the remainder of the present disclosure, the anode-side support member 214 will also be referred to as the “anode current collector 214” and the cathode-side support member 216 will also be referred to as the “cathode current collector 216.” In an example, each current collector 214, 216 comprises a rigid structure, such as a rigid metal plate or mesh, which is electrically connected to its corresponding electrode 102, 104 and its corresponding pan 210, 212, either directly or indirectly.

Each electrode can be electrically connected to its corresponding current collector with an electrical connector. For example, the anode 102 can be electrically connected to the anode current collector 214 by one or more anode-side electrical connectors 218 and/or the cathode 104 can be electrically connected to the cathode current collector 216 by one or more cathode-side electrical connectors 220. In FIG. 5, the electrical connectors 218 and 220 are shown generically as electrical leads or wires that are electrically connected to an electrode 102, 104 on one end and a corresponding current collector 214, 216 on the other end. Those having skill in the art will appreciate that other electrical connection structures can be used to provide the electrical connection between an electrode 102, 104 and its corresponding current collector 214, 216. For example, as described in more detail below, if there are one or more intermediate structures located between the electrode 102, 104 and the current collector 214, 216, then if the one or more intermediate structures comprise electrically conductive materials, then contact between the electrode 102, 104 and the intermediate structure(s) and contact between the intermediate structure(s) and the current collector 214, 216 can provide for an electrical conduction pathway between the current collector 214, 216 and the electrode 102, 104, or vice versa. In other examples (not shown), one or both electrodes 102, 104 can be configured to be in direct contact with the current collector 214, 216. For example, if the electrode 102, 104 is made from a woven metal mesh, and in particular a fine metal mesh, the electrode 102, 104 may be flexible and can be configured so that the electrode 102, 104 can be wrapped around a back side of the current collector 214, 216 so that the electrode 102, 104 can physically contact the edge or the back side of the current collector 214, 216. If the contact resistance between the material of the electrode 102, 104 and the material of the current collector 214, 216 is sufficiently low, then merely this contact alone may be sufficient to provide for an electrical connection between the electrode 102, 104 and the current collector 214, 216, even without the use of welds or other physical coupling. As noted above, in some examples, one or both of the electrodes 102, 104 and/or one or both of the current collectors 214, 216 can be made primarily or entirely from nickel, such as a nickel fine mesh or an expanded metal sheet made from nickel. Nickel has a very low contact resistance when it is in contact with another electrically conductive material, and the contact resistance is particularly low when a nickel structure is in physical contact with another nickel structure. Contact resistance also tends to be particularly low when there is contact between a nickel surface and a surface coated with a platinum group metal-based catalyst, which is a common type of catalyst on electrodes 102, 104 for water electrolysis.

As shown in FIG. 5, the electrolyzer cell 200 can also include one or more elastic elements (also sometimes referred to as “mattresses”) that can provide a controlled load to bias a corresponding electrode toward the AEM 106, e.g., so that the proximal side of the electrode 102, 104 will be in contact with the structure on the proximal side of the electrode 102, 104 (which, as shown in FIGS. 4A-4H can be either the AEM 106 or a corresponding porous layer 108, 110). In FIG. 5, the electrolyzer cell 200 includes an anode-side elastic element 222 and a cathode-side elastic element 224. The compressive force produced by the one or more elastic elements 222, 224 can act to load one or both of the electrodes 102, 104 onto the structure on its proximal side (i.e., the AEM 106 or the corresponding porous layer 108, 110, depending on the specific embodiment of the electrode assembly 100, such as in FIGS. 4A-4H) and create effective electrical contact across the active area of one or both electrodes 102, 104.

In an example, each elastic element 222, 224 that is present comprises a compressible and expandable structure that provides a controlled load when compressed. For example, in the example configuration shown in FIG. 5, the anode-side elastic element 222 can be compressed between the anode current collector 214 and the anode 102 and the load that results as the anode-side elastic element 222 tries to expand back to its fully expanded state pushes against the distal side of the anode 102 and biases the anode 102 inward (i.e., in the direction of its proximal side) toward the anode-side porous layer 108A and the AEM 106. Similarly, in the example configuration shown in FIG. 5, the cathode-side elastic element 224 can be compressed between the cathode current collector 216 and the cathode 104 and the load that results as the cathode-side elastic element 224 tries to expand back to its fully expanded state pushes against the distal side of the cathode 104 and biases the cathode 104 inward (i.e., in the direction of its proximal side) toward the cathode-side porous layer 110A and the AEM 106. In an example, one or both of the elastic elements 222, 224 are also electrically conductive (e.g., one or both of the elastic elements 222, 224 are made from or are coated with an electrically conductive material, such as nickel) so that the elastic element 222, 224 can conduct electricity from the current collector 214, 216 to the electrode 102, 104 or vice versa. In other words, if the elastic element 222, 224 comprises a conductive material, then the elastic element 222, 224 itself can provide electrical connection between the current collector 214, 216 and the electrode 102, 104 so that a separate electrical connector (such as the electrical connectors 218, 220 shown in FIG. 5) may not be necessary.

In the example shown in FIG. 5, an elastic element 222, 224 is included on both the anode-side and on the cathode-side of the AEM 106, e.g., such that the anode-side elastic element 222 provides a first loading force that biases the anode 102 inward (i.e., in the direction of its proximal side) toward one side of the AEM 106, and the cathode-side elastic element 224 provides a second loading force that biases the cathode 104 inward (i.e., in the direction of its proximal side) toward the other side of the AEM 106. In other examples (not shown), an electrolyzer cell can include an elastic element on only one side of the AEM 106 (e.g., with only an anode-side elastic element and with the cathode-side elastic element omitted, or vice versa with only a cathode-side elastic element and with the anode-side elastic element omitted). In such a configuration, the elastic element 222, 224 on only one side of the AEM 106 can be configured to produce enough compressive load so that both electrodes 102, 104 will be compressed against the structure or structures on the proximal sides of the electrodes 102, 104 (which, as shown in FIGS. 4A-4H can be either the AEM 106 or a corresponding porous layer 108, 110).

For example, if the configuration of FIG. 5 were modified to only include the anode-side elastic element 222 and to not include a cathode-side elastic element, then the anode-side elastic element 222 could be configured to produce sufficient compressive load not only to bias the anode 102 inward toward the anode-side porous layer 108A, but also to further bias all of the anode 102, the anode-side porous layer 108A, the AEM 106, and the cathode-side porous layer 110A toward the cathode 104 such that the cathode-side porous layer 110A is compressed into the proximal side of the cathode 104. Alternatively, if the configuration of FIG. 5 were modified to only include the cathode-side elastic element 224 and to not include an anode-side elastic element, then the cathode-side elastic element 224 could be configured to produce sufficient compressive load not only to bias the cathode 104 inward toward the cathode-side porous layer 110A, but also to further bias all of the cathode 104, the cathode-side porous layer 110A, the AEM 106, and the anode-side porous layer 108A toward the anode 102 such that the anode-side porous layer 108A is compressed into the proximal side of the anode 102.

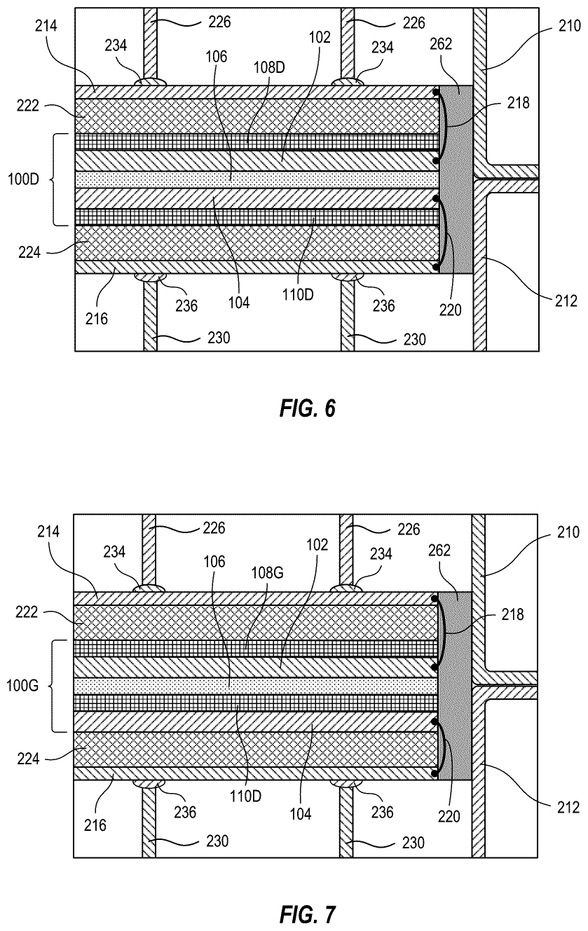

In examples wherein a particular porous layer 108, 110 is on the distal side of its corresponding electrode 102, 104 (e.g., as is the case with both porous layers 108D and 110D in the electrode assembly 100D of FIG. 4D, or as is the case with either the anode-side porous layer or the cathode-side porous layer in the electrode assemblies 100E, 100F, 100G, and 100H of FIGS. 4E-4H), then the elastic element 222, 224 that corresponds with that porous layer 108A, 110 can impart its controlled load directly onto the corresponding porous layer 108, 110 rather than onto the corresponding electrode 102, 104 as shown in the configuration of FIG. 5. FIG. 6 shows an example of such a configuration, wherein the example electrode assembly 100D of FIG. 4D is included within the electrolyzer cell 200 of FIG. 5. As can be seen in FIG. 6, the anode-side elastic element 222 is positioned between the anode current collector 214 and the anode-side porous layer 108D and the cathode-side elastic element 224 is positioned between the cathode current collector 216 and the cathode-side porous layer 110D, so that the elastic elements 222, 224 engage with and can impart their controlled loads onto the porous layers 108D, 110D to bias each porous layer 108D, 110D toward its corresponding electrode 102, 104.

FIG. 7 shows an example of a configuration wherein one of the porous layers 108, 110 is located between the AEM 106 and its corresponding electrode 102, 104 (e.g., on the proximal side of the electrode 102, 104), while the other porous layer 108, 110 is located between the corresponding current collector 214, 216 and the corresponding electrode 102, 104 (e.g., on the distal side of the electrode 102, 104), which could also be between the corresponding elastic element 222, 224 and the corresponding electrode 102, 104 if an elastic element 222, 224 is included on that side of the AEM 106. Specifically, FIG. 7 shows a configuration wherein the example electrode assembly 100G of FIG. 4G is included within the electrolyzer cell 200 of FIG. 5. As can be seen in FIG. 7, the anode-side elastic element 222 is positioned between the anode current collector 214 and the anode-side porous layer 108G so that the anode-side elastic element 222 engages with and imparts its controlled load onto the anode-side porous layer 108G, which biases the anode-side porous layer 108 toward the anode 102 and toward the AEM 106. The cathode-side elastic element 224 in the example of FIG. 7 is positioned between the cathode current collector 216 and the cathode 104 so that the cathode-side elastic element 224 engages with and imparts its controlled load onto the cathode 104, which biases the cathode 104 toward the cathode-side porous layer 110 and toward the AEM 106. A similar, but reversed configuration could be implemented if the electrode assembly 100H of FIG. 4H were to be implemented.

Returning to FIG. 5, in an example, each current collector 214, 216 can be coupled to its corresponding pan 210, 212, e.g., so that the current collector 214, 216 is electrically connected to its corresponding pan 210, 212, which can provide part of an electrical pathway between the pan 210, 212 and its corresponding electrode 102, 104. In an example, one or both of the pan assemblies 202, 204 include one or more conductive ribs that extend between the current collector 214, 216 and a specified wall of the pan. For example, the anode pan assembly 202 can include one or more anode-side conductive ribs 226 that extend between the anode current collector 214 and a specified wall of the anode-side pan 210 (e.g., a back wall 228 of the pan 210). Similarly, the cathode pan assembly 204 can include one or more cathode-side conductive ribs 230 that extend between the cathode current collector 216 and a specified wall of the cathode-side pan 212 (e.g., a back wall 232 of the pan 212) and the cathode current collector 216. The one or more anode-side ribs 226 can each be welded to the specified wall of the anode-side pan 210 (e.g., the back wall 228) while the one or more cathode-side ribs 230 can each be welded to the specified wall of the cathode-side pan 212 (e.g., the back wall 232).

The one or more ribs 226, 230 of each pan assembly 202, 204 can be electrically coupled to its corresponding current collector 214, 216 by one or more welds, e.g., one or more welds 234 that electrically couple the anode current collector 214 to the one or more anode-side ribs 226 and one or more welds 236 that electrically couple the cathode current collector 216 to the one or more cathode-side ribs 230. In an example, the electrodes 102, 104 can be electrically connected to the one or more welds 234, 236, and thus can be electrically connected to the one or more ribs 226, 230. In examples wherein the one or more current collectors 214, 216 are made from a conductive material, such as nickel, than each electrode 102, 104 can be electrically connected to its corresponding current collector 214, 216, such as via an electrical connector 218, 220, which facilitates the electrical connection between the electrode 102, 104 and its corresponding ribs 226, 230 (via the electrical connection between the electrode 102, 104 and the corresponding current collector 214, 216, which is electrically connected to the one or more ribs 226, 230 by the one or more welds 234, 236). In other examples, not shown, one or both of the electrodes 102, 104 can be in direct physical contact with its corresponding current collector 214, 216, which can allow current to flow to or from an electrode 102, 104 to its corresponding ribs 226, 230 via the direct physical contact between the electrode 102, 104 and the current collector 214, 216 and via the welds connecting the current collector 214, 216 to the ribs 226, 230.

In examples wherein there is an elastic element 222, 224 or some other intermediate structure between an electrode 102, 104 and its corresponding current collector 214, 216, the elastic element 222, 224 and/or the other intermediate structure cab include a conductive material (e.g., a woven metal elastic element 222, 224 or an elastic element 222, 224 that is coated with a conductive material), then current can flow from a rib 226, 230 to the corresponding current collector 214, 216, then to the corresponding elastic element 222, 224, and then to the corresponding electrode 102, 104, or vice versa from the electrode 102, 104 to the corresponding elastic element 222, 224, then to the corresponding current collector 214, 216, and then to the corresponding ribs 226, 230.

During operation of the electrolyzer cell 200, current can flow from a conductor (e.g., similar to the anode lead 34 in the electrolyzer cell 10 of FIG. 1) into the anode-side pan 210. Next, the current can flow from the anode-side pan 210 to the one or more anode-side ribs 226 (e.g., through welds between the ribs 226 and the back wall 228 of the anode-side pan 210), then to the anode current collector 214 via the one or more welds 234, and into the anode 102 (e.g., via the one or more anode-side electrical connectors 218, or via contact between the anode current collector 214, the anode-side elastic element 222, and the anode 102). The current can then pass between the anode 102 and the cathode 104 via the AEM 106 (e.g., in the form of ionic current, which in the case of the AEM 106 and the alkaline cell 200, involves OH⁻ ions flowing from the cathode side of the AEM 106 to the anode side). The current then flows (once again as electrical current) from the cathode 104 to the cathode current collector 216 (e.g., via the one or more cathode-side electrical connectors 220, or via contact between the cathode 104, the cathode current collector 216, and the cathode-side elastic element 224), where it can then flow from the cathode current collector 216 to the one or more cathode-side ribs 230 via the one or more welds 236. Next, the current can flow from the one or more ribs 230 to the cathode-side pan 212 (such as via welds between the one or more ribs 230 and the back wall 232 of the cathode-side pan 212), and finally out of the electrolyzer cell 200 via a conductor (e.g., similar to the cathode lead 36 in the electrolyzer cell 10 of FIG. 1) that is electrically connected to the cathode-side pan 212.

In an example, one or more, and in some examples all, of the structures described so far for the electrolyzer cell 200 of FIG. 5 are planar or substantially planar and can be aligned to be parallel or substantially parallel to each other, as shown in FIG. 5. For example, one or any combination of the following, including all of the following, can be planar or substantially planar, and one or any combination of the following, including all of the following, can be aligned to be parallel or substantially parallel to each other, including: a main (e.g., largest) face of the anode-side pan 210 (such as the back wall 228 of the anode-side pan 210); the anode current collector 214; the cathode-side elastic element 224; the anode 102; the anode-side porous layer 108A; the AEM 106; the cathode-side porous layer 110A; the cathode 104; the cathode-side elastic element 224; the cathode current collector 216; and a main (e.g., largest) face of the cathode-side pan 212 (such as the back wall 232 of the cathode-side pan 212). In an example, one or more, and in some examples all, of those same structures can be rectangular or substantially rectangular is cross-sectional shape.

The electrolyzer cell 200 can include a solution supply for the corresponding specified solution 112, 114 to be infused onto or into one or both of the porous layers 108A, 110A, such as a first solution supply to deliver and/or resupply the first specified solution 112, 114 to the anode-side porous layer 108A and/or a second solution supply to deliver and/or resupply the second specified solution 114 to the cathode-side porous layer 110A. In the example shown in FIG. 5, the solution supply for one or both of the specified solutions 112, 114 comprises a solution reservoir, such as a first solution reservoir 238 for the first specified solution 112 and/or a second solution reservoir 240 for the second specified solution 114. In an example, one or both of the solution reservoirs 238, 240 can be part of a corresponding pan assembly 202, 204. The first solution reservoir 238 can be part of the anode pan assembly 202 because the first specified solution 112 is to be infused into or onto the anode-side porous layer 108A, and the second solution reservoir 240 can be part of the cathode pan assembly 204 because the second specified solution 114 is to be infused into or onto the cathode-side porous layer 110A. The specified solution 112, 114 in each solution reservoir 238, 240 can be resupplied via a solution feed line, such as a first solution feed line 242 to resupply the first solution reservoir 238 with the first specified solution 112 and/or a second solution feed line 244 to resupply the second solution reservoir 240 with the second specified solution 114.

The first solution reservoir 238 can be configured so that a portion of the first specified solution 112 from the first solution reservoir 238 will come into contact with at least an infusion portion 246 of the anode-side porous layer 108A and/or the second solution reservoir 240 can be configured so that a portion the second specified solution 114 from the second solution reservoir 240 will come into contact with at least an infusion portion 248 of the cathode-side porous layer 110A. In the example shown in FIG. 5, one or both of the solution reservoirs 238, 240 are located below a bottom end of a corresponding pan 210, 212 (e.g., with the first solution reservoir 238 being located below a bottom end of the anode-side pan 210 and/or with the second solution reservoir 240 being located below a bottom end of the cathode-side pan 212). In such a configuration, the anode-side porous layer 108A can be configured so that its infusion portion 246 extends out of the anode-side pan 210 and into the first solution reservoir 238 where the infusion portion 246 comes into contact with the first specified solution 112 and/or the cathode-side porous layer 110A can be configured so that its infusion portion 248 extends out of the cathode-side pan 212 and into the second solution reservoir 240 where the infusion portion 248 comes into contact with the second specified solution 114. When the infusion portion 246 of the anode-side porous layer 108A comes into contact with the first specified solution 112 in the first solution reservoir 238, the porous microstructure of the anode-side porous layer 108A can draw the first specified solution 112 into the body of the anode-side porous layer 108A, such as by capillary action or another diffusion mechanism (as represented by the lines and arrows designated with reference number 250 in FIG. 5), where the first specified solution 112 can be available to the anode 102. Similarly, when the infusion portion 248 of the cathode-side porous layer 110A comes into contact with the second specified solution 114 in the second solution reservoir 240, the porous microstructure of the cathode-side porous layer 110A can draw the second specified solution 114 up into the body of the cathode-side porous layer 110A by a similar mechanism (as represented by the lines and arrows designated with reference number 252 in FIG. 5), where the second specified solution 114 can be available to the cathode 104.

In other examples (not shown), the solution reservoirs 238, 240 or other solution supplies can be configured to deliver the specified solutions 112, 114 to other locations of the porous layers 108A, 110A. For example, one or both of the solution reservoirs 238, 240 could be located above the pans 210, 212 so that each specified solution 112, 114 can flow via gravity down into contact with its corresponding porous layer 108A, 110A. Or one or both of the solution feed lines 242, 244 can flow directly into its corresponding porous layer 108A, 110A from one or more of the bottom, a side, and the top of the corresponding porous layer 108A, 110A. The electrolyzer cell 200 and the electrode assembly 100 of the present disclosure is not limited to a specific solution supply structure and configuration so long as the particular solution supply used can supply a sufficient flow rate of the specified solution 112, 114 to the corresponding porous layer 108A, 110A so that as the reactants within each specified solution 112, 114 are consumed at the electrodes 102, 104, and enough of the specified solution 112, 114 is resupplied to maintain a specified state for the electrolyzer cell 200 (such as a specified pH differential between the first local pH at the anode 102 and the second local pH at the cathode 104, a specified gas production rate at a specified current density, etc.).

As mentioned above, as the specified solutions 112, 114 are supplied to the porous layers 108A, 110A (such as via the solution feed lines 242, 244 and the solution reservoirs 238, 240), the infusion 250, 252 of the specified solutions 112, 114 through the porous layers 108A, 110A to the electrodes 102, 104 occurs. If electrical current is applied to the electrolyzer cell 200 (e.g., as described above with current flowing in through a cathode lead to the cathode-side pan 212, to the cathode-side ribs 230, to the cathode current collector 216, to the cathode 104, across the AEM 106 (e.g., as ionic current) to the anode 102, to the anode current collector 214, to the anode-side ribs 226, to the anode-side pan 210 and out through an anode lead), it can drive the OER [1] at the anode 102 and the HER [2] at the cathode 104. As OH⁻ ions are generated at the cathode 104 via the HER [2] (along with H₂ gas), the building OH⁻ concentration on the cathode side of the AEM 106 (e.g., at the cathode 104 or within the solution infused in the cathode-side porous layer 110A) can drive OH⁻ ions to diffuse or otherwise pass through the AEM 106 from the cathode side to the anode side, e.g., generating ionic current across the AEM 106. The transferred OH⁻ ions can then become available to the anode 102 (e.g., by diffusing into the solution infused in the anode-side porous layer 108A and then coming into contact with the anode 102), where the OH⁻ ions can be consumed via the OER [1] to generate O₂ gas and H₂O.

If reactant for the OER [1] (i.e., OH⁻ ions) is being delivered to the anode 102 via the infusion 250 of the first specified solution 112 through the anode-side porous layer 108A (and via transfer of OH⁻ anions across the AEM 106), then the electrolyzer cell 200 can be operated without having to flow anolyte solution through the anode-side chamber 206, as is required with conventional electrolysis such as in the electrolyzer cell 10 of FIG. 1. Similarly, if reactant for the HER [2] (i.e., H₂O) are being delivered to the cathode 104 via the infusion 252 of the second specified solution 114 through the cathode-side porous layer 110A, then the electrolyzer cell 200 can be operated without having to flow catholyte solution through the cathode-side chamber 208, as is done with conventional electrolysis such as in the electrolyzer cell 10 of FIG. 1. Rather, as the O₂ gas is generated by the OER [1] it can flow freely through the anode-side chamber 206 without having to bubble through anolyte solution (as represented by the lines and arrows designed with reference number 254 in FIG. 5). Similarly, as the H₂ gas is generated by the HER [2] it can flow freely through the cathode-side chamber 208 without having to bubble through catholyte solution (as represented by the lines and arrows designed with reference number 256 in FIG. 5). This reduces the chances of the generated O₂ gas 254 blinding the anode 102 or of the generated H₂ gas 256 blinding the cathode 104 and hindering the Half Reactions [1] and [2] over at least a portion of the area of the electrodes 102, 104, which has been known to reduce the efficiency of conventional electrolyzer cells like the electrolyzer cell 10 of FIG. 1.

In this way, one or both of the chambers 206, 208 can act as product gas collection chambers or as manifolds to deliver the product gas out of the electrolyzer cell 200 instead of being electrolyte supply chambers (like the anolyte chamber 18 and the catholyte chamber 24 in the conventional electrolyzer cell 10 of FIG. 1). In the example shown in FIG. 5, the anode-side chamber 206 can act as an O₂ gas manifold to flow the generated O₂ gas 254 up through the electrolyzer cell 200 and out through an O₂ gas outlet 258 and the cathode-side chamber 208 can act as an H₂ gas manifold to flow the generated H₂ gas 256 up through the electrolyzer cell 200 and out through an H₂ gas outlet 260. In an example, the electrolyzer cell 200 can also include one or more gaskets or seals 262 to seal the O₂ gas chamber 206 from the H₂ gas chamber 208 so that produced O₂ gas 256 does not leak into the H₂ gas chamber 208 and so that produced H₂ gas 256 does not leak into the O₂ gas chamber 206 and cross-contaminate the product gases 254, 256 (in particular to prevent or limit contamination of the generated H₂ gas 256, which is a preferred product of the electrolyzer cell 200 in certain examples, by O₂ gas). In the example shown in FIG. 5, the one or more seals 262 form a barrier between edges of the pans 210, 212 and the assembly that includes the electrodes 102, 104, the AEM 106, the one or more porous layers 108, 110, the one or more elastic elements 222, 224, and the current collectors 214, 216. Examples of materials that can be used to form the one or more seals 262 include, but are not limited to: one or more rubbers (synthetic or natural), silicone, or a fluoropolymer such as polytetrafluoroethylene (PTFE or TEFLON).

Additional details regarding various components or substructures that can be used in electrolyzer cells according to the present disclosure are described in U.S. Pat. No. 11,390,956, issued on Jul. 19, 2022, entitled “ANODE AND/OR CATHODE PAN ASSEMBLIES IN AN ELECTROCHEMICAL CELL, AND METHODS OF USE AND MANUFACTURE THEREOF;” in U.S. Pat. No. 11,431,012, issued on Aug. 30, 2022, entitled “ELECTROCHEMICAL CELL WITH GAP BETWEEN ELECTRODE AND MEMBRANE, AND METHODS TO USE AND MANUFACTURE THEREOF;” in U.S. Pat. No. 11,444,304, issued on Sep. 13, 2022, entitled “ANODE AND/OR CATHODE PAN ASSEMBLIES IN AN ELECTROCHEMICAL CELL, AND METHODS TO USE AND MANUFACTURE THEREOF;” in U.S. patent application Ser. No. 17/936,322, filed on Sep. 28, 2022, entitled “SYSTEMS AND METHODS TO MAKE HYDROGEN GAS WITH A STEADY-STATE PH DIFFERENTIAL;” in U.S. patent application Ser. No. 18/162,290, filed on Jan. 31, 2023, entitled “FLATTENED WIRE MESH ELECTRODE FOR USE IN AN ELECTROLYZER CELL;” in U.S. patent application Ser. No. 18/163,010, filed on Feb. 1, 2023, entitled “ELECTROLYZER CELL AND METHODS OF USING AND MANUFACTURING THE SAME;” and in U.S. patent application Ser. No. 18/166,340, filed on Feb. 8, 2023, entitled “NANOPOROUS MEMBRANE SUPPORT IN AN ELECTROLYZER CELL;” the disclosures of all of which are incorporated herein by reference in their entireties.

### EXAMPLES

Various embodiments of the present invention can be better understood by reference to the following EXAMPLES which are offered by way of illustration. The present invention is not limited to the EXAMPLES given herein.

### Example 1

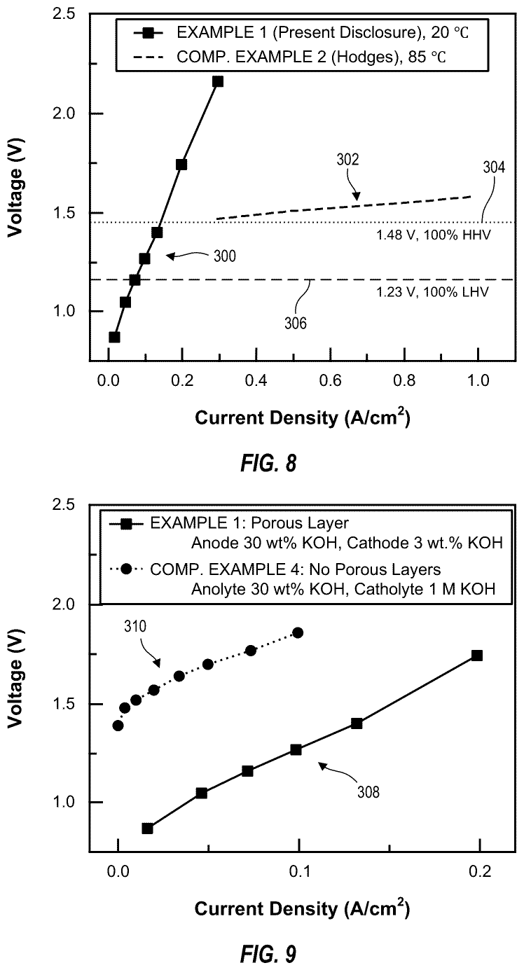

An electrolyzer cell having a substantially similar structure to that shown in FIG. 5 was assembled. Both the anode (e.g., anode 102) and the cathode (e.g., cathode 104) comprised fine woven mesh nickel electrodes coated with a platinum-group metal catalyst. The separator (e.g., separator 106) was an anion-exchange membrane (AEM) sold under the trade name FUMASEP™ FAA-2-20 by Fumatech BWT GmbH, Bietigheim-Bissingen, Germany. The two porous layers (e.g., anode-side porous layer 108 and cathode-side porous layer 110) comprised a low-lint fibrous paper-based product sold under the trade name KIMWIPESm by Kimberly-Clark Corp., Irving, TX, USA. The porous layer that was to be placed between the anode and the AEM (e.g., the anode-side porous layer 108) was soaked and infused with a first specified solution consisting of a 30 wt. % KOH solution (pH of about 14.3). The porous layer that was to be placed between the cathode and the AEM (e.g., the cathode-side porous layer 110) was soaked and infused with a second specified solution consisting of a 3 wt. % KOH solution (pH of between about 13 and 14). Therefore, the pH differential (ΔpH) between the anode-side porous layer and the cathode-side porous layer was about 1.1. The cell was operated at a temperature of 20° C. at various current densities between about 0.01 amps per square centimeter (A/cm²) and about 0.3 A/cm². The voltage required to operate at the various current densities is included in FIG. 8 as data series 300.

### Comparative Example 2

There has been some research on electrolyzer cells that use capillary action as a mechanism to supply electrolyte to one or both electrodes. Hodges et al., “A high-performance capillary-fed electrolysis cell promises more cost-competitive renewable hydrogen,” Nature Communications, Vol. 13 (2022), 1304, https://doi.org/10.1038/s41467-022-28953-x (hereinafter “Hodges”) describes a cell that used “capillary-induced transport [of electrolyte] along a porous inter-electrode separator” (hereinafter “the Hodges Cell”). The Hodges Cell comprised a single porous polyether sulfone (PES) separator sandwiched between the anode and the cathode. The bottom end of the PES separator was dipped in a reservoir containing KOH electrolyte, and “capillary-induced, upward, in-plane, movement of electrolyte” supplied the KOH to the PES separator and “[t]he electrodes [drew] in liquid [electrolyte] laterally from the separator.” Thus, Hodges PES sheet acted as both a separator between the anode and the cathode and as a structure to supply KOH to the anode and the cathode via capillary action.

Hodges operated its cell at various current densities from about 0.3 A/cm² to about 1 A/cm² at a temperature of 85° C. The data collected in the Hodges paper on the voltage required at the various current densities is shown in FIG. 8 as data line 302. As can be seen in FIG. 8, the Hodges Cell (data line 302) was not able to operate at a voltage below the higher heating value (HHV) of about 1.48 V (line 304). In contrast, even at room temperature (about 20° C.), cell voltage at low current densities for the cell that include the infused porous layers of EXAMPLE 1 compares favorably with the Hodges Cell. The inventors believe this is attributable in part to the reduction in the apparent open circuit voltage that can be achieved with the pH differential between the anode and the cathode that is provided by the infused porous layers. The cell that includes the infused porous layers of EXAMPLE 1 allows operation substantially below the thermoneutral voltage for the water electrolysis Half Reactions [1] and [2], i.e., the higher heating value (HHV) of 1.48 V (line 304), which the Hodges Cell was unable to achieve. Moreover, as shown in FIG. 8, at current densities of about 100 milliamps per square centimeter (mA/cm²) (about 0.1 A/cm²) or less, the cell including infused porous layers of EXAMPLE 1 was able to operate below the lower heating value (LHV) voltage of 1.23 V (line 306), even when operating at room temperature (about 20° C.).

In addition, since the PES separator in the Hodges Cell supplied the same KOH solution to both the anode and the cathode, the Hodges Cell is not able to operate with different local pH environments at the anode and the cathode, and thus cannot provide for a pH differential between the two sides of its electrolyzer cell or with the improved open cell voltage provided by a pH differential. Also, even if a pH differential were possible with the Hodges cell, the PES separator would allow both OH⁻ anions and K⁺ cations to pass freely back and forth across the PES separator, eventually resulting in pH equilibration.

### Comparative Example 3

In order to test the use of porous PES sheets (similar to the PES separator in the Hodges Cell) as the infused porous layers in the electrolyzer cells of the present disclosure, an electrolysis cell similar to the cell of EXAMPLE 1 was assembled, with the only difference being that instead of using paper (KIMWIPES™ low-lint paper) as the porous layers, sheets of porous PES (similar to the PES used in the Hodges Cell of COMPARATIVE EXAMPLE 2) were used as the porous layers. However, when the cell was operated with the PES sheet porous layers, performance was extremely poor—i.e., a high operating voltage of about 2.9 V, even when operating at extremely low current densities below 1 mA/cm² (0.001 A/cm²). In contrast, the cell of EXAMPLE 1 was able to operate at cell voltages that were below the LHV 306 of 1.23 V up to a current density of about 0.1 A/cm² (100 mA/cm²), and below the HHV 304 of 1.48 V up to a current density of about 0.2 A/cm² (200 mA/cm²).

### Comparative Example 4

In order to compare the effect of using the infused porous layers in the electrolyzer cell with a conventional electrolyzer cell with electrolyte chambers operating at a comparable pH differential, a conventional electrolyzer cell similar to the configuration shown in FIG. 1 was assembled. The anode, cathode, and AEM of the conventional electrolyzer cell of COMPARATIVE EXAMPLE 4 were the same as the anode, cathode, and AEM in the electrolyze cell of EXAMPLE 1. The anolyte solution that was fed into the anode chamber of the conventional cell of COMPARATIVE EXAMPLE 4 consisted of a 30 wt. % KOH (pH of about 14.84) (i.e., the anolyte solution was the same as the first specified solution that was infused into the anode-side porous layer in EXAMPLE 1). The catholyte solution that was fed into the cathode chamber of the conventional cell of COMPARATIVE EXAMPLE 4 consisted of a 1 M KOH solution (pH of about 14) (which is similar to the second specified solution that was infused into the cathode-side porous layer in EXAMPLE 1). Therefore, the pH differential (ΔpH) between the anode-side porous layer and the cathode-side porous layer was about 0.84 for the conventional electrolyzer cell of COMPARATIVE EXAMPLE 4.

The current density versus the voltage for the electrolyzer cell of EXAMPLE 1 (data series 308) and for the conventional electrolyzer cell of COMPARATIVE EXAMPLE 4 (data series 310) are plotted in FIG. 9. As can be seen in FIG. 9, the electrolyzer cell with the porous layers of EXAMPLE 1 (data series 308) performed significantly better than the conventional electrolyzer cell of COMPARATIVE EXAMPLE 4 (data series 310), even though both cells were operated with a comparable pH differential such that similar performance would be expected. The data in FIG. 9 indicates that the improved performance of the electrolyzer cell with the infused porous layers of EXAMPLE 1 is due to more than simply the pH differential itself, but rather that the inclusion of the infused porous layers surprisingly further enhances the improved performance achievable by operating the electrolyzer cell with a pH differential.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An electrochemical cell comprising:
a first electrode configured for a first electrochemical half reaction;
a first electrolyte solution in contact with the first electrode;
a second electrode configured for a second electrochemical half reaction;
a second electrolyte solution in contact with the second electrode;
a separator positioned between the first electrode and the second electrode; and
a first porous layer in contact with the first electrode, wherein the first porous layer is infused with a first specified solution comprising a first reactant for the first electrochemical half reaction.

2. The electrochemical cell of claim 1, wherein the separator comprises an anion exchange membrane.

3. The electrochemical cell of claim 1, wherein the porous layer comprises at least one of: a paper layer, a felt layer, a fibrous woven layer, a fibrous non-woven layer, a porous polymer layer, and a foam layer.

4. The electrochemical cell of claim 1, wherein the first specified solution comprises the first electrolyte solution.

5. The electrochemical cell of claim 1, wherein the first porous layer is between the first electrode and the separator.

6. The electrochemical cell of claim 5, wherein the first porous layer is in contact with the separator.

7. The electrochemical cell of claim 1, further comprising a second porous layer in contact with the second electrode, wherein the second porous layer is infused with a second specified solution comprising a second reactant for the second electrochemical half reaction.

8. The electrochemical cell of claim 6, wherein the second specified solution comprises the second electrolyte solution.

9. The electrochemical cell of claim 1, further comprising a solution supply to resupply the first specified solution to the first porous layer.

10. The electrochemical cell of claim 1, wherein the first electrode is an anode of the electrochemical cell, the second electrode is a cathode of the electrochemical cell, the first electrochemical half reaction is an oxygen evolution reaction that produces oxygen gas (O₂), and the second electrochemical half reaction is a hydrogen evolution reaction that produces hydrogen gas (H₂).

11. The electrochemical cell of claim 10, wherein the first electrolyte solution has a first pH, the second electrolyte solution has a second pH, and the first pH is higher than the second pH.

12. The electrochemical cell of claim 10, further comprising a second porous layer in contact with the cathode, wherein the second porous layer is infused with a second specified solution comprising a second reactant for the hydrogen evolution reaction, and wherein the first reactant comprises hydroxide ions (OH⁻) and the second reactant comprises water (H₂O).

13. A method of electrolysis, the method comprising:
providing an electrochemical cell comprising a separator having a first side and an opposing second side, a first electrode configured for a first electrochemical reaction positioned on the first side of the separator, a second electrode configured for a second electrochemical reaction positioned on the second side of the separator, and a first porous layer in contact with the first electrode;
infusing the first porous layer with a first electrolyte solution comprising a first reactant for the first electrochemical half reaction;
contacting the second electrode with a second electrolyte solution;
passing current between the first electrode and the second electrode; and
producing hydrogen gas (H₂) at one of the first electrode and the second electrode, and producing oxygen gas (O₂) at the other of the first electrode and the second electrode.

14. The method of claim 13, wherein the separator is an anion exchange membrane.

15. The method of claim 13, wherein the porous layer comprises at least one of: a paper layer, a felt layer, a fibrous woven layer, a fibrous non-woven layer, a porous polymer layer, and a foam layer.

16. The method of claim 13, wherein the first porous layer is between the first electrode and the separator.

17. The method of claim 16, wherein the first porous layer is in contact with the separator.

18. The method of claim 13, wherein the electrochemical cell further comprises a second porous layer in contact with the second electrode and wherein the second electrolyte solution comprises a second reactant for the second electrochemical half reaction, the method further comprising infusing the second porous layer with the second electrolyte solution.

19. The method of claim 13, wherein the second porous layer is between the second electrode and the separator.

20. The method of claim 13, further comprising resupplying the first specified solution to the first porous layer.

21. The method of claim 13, wherein the first electrode is an anode of the electrochemical cell, the second electrode is a cathode of the electrochemical cell, the first electrochemical half reaction is an oxygen evolution reaction that produces the oxygen gas (O₂), and the second electrochemical half reaction is a hydrogen evolution reaction that produces the hydrogen gas (H₂).

22. The method of claim 21, wherein the first electrolyte solution has a first pH, the second electrolyte solution has a second pH, and the first pH is higher than the second pH.

23. The method of claim 21, wherein the electrochemical cell further comprises a second porous layer in contact with the cathode, wherein the second porous layer is infused with the second electrolyte solution, wherein the second electrolyte solution comprises a second reactant for the hydrogen evolution reaction, and wherein the first reactant comprises hydroxide ions (OH⁻) and the second reactant comprises water (H₂O).
